(19) United States
(12) Patent Application Publication
(10) Pub. No.: US 2025/0020184 A1
(43) Pub. Date: Jan. 16, 2025

(54) Vibration damper and motor vehicle with an active chassis

(71) Applicant: Dr. Ing. h. c. F. Porsche Aktiengesellschaft, Stuttgart (DE)

(72) Inventors: Swen Zschocke, Wiernsheim-Serres (DE); Jochen Liebold, Stuttgart (DE); Thomas Witte, Ditzingen-Heimerdingen (DE)

(73) Assignee: Dr. Ing. h. c. F. Porsche Aktiengesellschaft, Stuttgart (DE)

(21) Appl. No.: 18/655,373

(22) Filed: May 6, 2024

(30) Foreign Application Priority Data
Jul. 13, 2023 (DE) 10 2023 118 621.3

(51) Int. Cl. F16F 9/06; F16F 9/34

(52) U.S. Cl. CPC F16F 9/062; F16F 9/34; F16F 2222/12

(57) ABSTRACT

A vibration damper having a damper piston, which can be moved back and forth in a main pipe with hydraulic medium in an axial direction relative to the main pipe. The main pipe is arranged in a container pipe. An intermediate pipe is arranged between the main pipe and the container pipe. The main pipe, the intermediate pipe and the container pipe are arranged coaxially in a three-pipe damper. The damper piston is attached to an end of a piston rod. The three-pipe damper is equipped with a hydraulic end position damper. The three-pipe damper has a central valve block with two damper valve devices at its end facing away from the piston rod, which is partially surrounded by an air spring. The three-pipe damper has a gas balance volume at its piston rod end, which is arranged in an annular space between the intermediate pipe and the container pipe.

### CROSS-REFERENCE TO RELATED APPLICATION

This application claims priority to German Patent Application No. 10 2023 118 621.3, filed Jul. 13, 2023, the content of such application being incorporated by reference herein in its entirety.

### FIELD OF THE INVENTION

The invention relates to a vibration damper having a damper piston, which can be moved back and forth in a main pipe with hydraulic medium in an axial direction relative to the main pipe, wherein the main pipe is arranged in a container pipe, wherein an intermediate pipe is arranged between the main pipe and the container pipe, wherein the main pipe, the intermediate pipe and the container pipe are arranged coaxially in a three-pipe damper, wherein the damper piston is attached to an end of a piston rod, wherein the three-pipe damper is equipped with a hydraulic end position damper.

### BACKGROUND OF THE INVENTION

From the German disclosures DE 10 2018 220 630 A1 and DE 10 2019 206 455 A1, which are incorporated by reference herein, motor vehicle vibration dampers with a three-pipe damper and an air spring are known, wherein the three-pipe damper comprises a central valve block with two damper valves. From the international disclosure WO 2018/092111 A1, which are incorporated by reference herein, the German disclosure DE 10 2006 054 257 A1, which are incorporated by reference herein, and the American patent U.S. Pat. No. 9,702,424 B2, which are incorporated by reference herein, a motor vehicle vibration damper with a three-pipe damper and a hydraulic end position damper is known.

### SUMMARY OF THE INVENTION

Described herein is a vibration damper having a damper piston, which can be moved back and forth in a main pipe with hydraulic medium in an axial direction relative to the main pipe, wherein the main pipe is arranged in a container pipe, wherein an intermediate pipe is arranged between the main pipe and the container pipe, wherein the main pipe, the intermediate pipe and the container pipe are arranged coaxially in a three-pipe damper, wherein the damper piston is attached to an end of a piston rod, wherein the three-pipe damper is equipped with a hydraulic end position damper, such that the three-pipe damper has a central valve block with two damper valve devices at its end facing away from the piston rod, which is partially surrounded by an air spring, wherein the three-pipe damper has a gas balance volume at its piston rod end, which is arranged in an annular space between the intermediate pipe and the container pipe. On the one hand, this provides a vibration damper or shock absorber that enables very comfortable operation of a motor vehicle equipped with the vibration damper or shock absorber both at high frequencies and low frequencies. This provides an elegant solution to the installation space conflict resulting from the combination of the gas balance volume and the air spring on the three-pipe damper. At the piston end of the three-pipe damper, the annular space between the intermediate pipe and the container pipe is effectively used to accommodate the gas balance volume. The gas balance volume is advantageously illustrated with a gas bag containing a gas, such as air. The gas bag is formed from a gas-tight flexible material. The gas bag is located between the intermediate pipe and the container pipe and is connected with a bayonet valve. During operation of the vibration damper, the gas bag provides separation between oil and gas. Moreover, the gas bag prevents the oil from foaming. At the end of the three-pipe damper facing away from the piston rod, a sufficiently large air volume may be provided particularly advantageously for the air spring by partially surrounding the central valve block with the air spring. The resulting disadvantage with regard to the connection of hydraulic lines to the central valve block is deliberately accepted. The two damper valve devices advantageously each include a check valve. One of the damper valve devices also comprises a rebound valve. The other damper valve device advantageously comprises a pressure stage valve in addition to the check valve.

A preferred example embodiment of the vibration damper is characterized in that an axial dimension of the gas balance volume in the annular space between the intermediate pipe and the container pipe is longer than one tenth of the axial dimension of the main pipe of the three-pipe damper. This provides the advantage, among other things, that the gas balance volume can be fully integrated into the three-pipe damper. The axial dimension of the gas balance volume in the annular space between the intermediate pipe and the container pipe of the three-pipe damper is advantageously even greater than one third of the axial dimension of the main pipe of the three-pipe damper. The upper limit for the axial dimension of the gas balance volume in the annular space between the intermediate pipe and the container pipe has proven to be half the axial dimension of the main pipe of the three-pipe damper in studies and considerations that were made during the design of the vibration damper.

A further preferred example embodiment of the vibration damper is characterized in that a gas bag is arranged in the annular space between the intermediate pipe and the container pipe, which serves to represent the gas balance volume. The gas bag enables a simple way to separate the gas balance volume from hydraulic medium in the annular space between the intermediate pipe and the container pipe. The gas bag is also referred to as a ‘gasbag’. At the piston rod end of the damper pipe, a seal guide unit is advantageously combined with a gas bag receptacle. A hydraulic pull stop, which serves to represent the hydraulic end position damping, is advantageously arranged coaxially and axially overlapping with the gas bag in the main pipe of the three-pipe damper.

A further preferred example embodiment of the vibration damper is characterized in that a radial distance between the main pipe and the intermediate pipe is less than a radial distance between the intermediate pipe and the container pipe. This has proven advantageous in terms of a convenient operation of the vibration damper or shock absorber during operation on a motor vehicle.

A further preferred example embodiment of the vibration damper is characterized in that the hydraulic end position damper comprises a hydraulic pull stop having a control sleeve, a control ring and a distance sleeve. The control sleeve advantageously serves to control a force build-up characteristic when the damper piston approaches its end position. The control ring advantageously serves to define a desired damping level. The spacer sleeve is advantageously used to represent a mechanical stop for the damper piston. The hydraulic pull stop is advantageously arranged in the container pipe in the axial direction completely overlapping with the previously described gas bag.

A further preferred example embodiment of the vibration damper is characterized in that the central valve block comprises a base block extending in extension of the container pipe and from which two damper valve blocks extend, which extend coaxially to each other in opposite directions radially outwards. The damper valve blocks are, where appropriate, components that are arranged separately from the base block. However, depending on the design, it may also be useful to connect the damper valve blocks, at least partially, integrally to the base block. The damper valve blocks advantageously serve to receive the damper valve devices. To connect the damper valve blocks to the three-pipe damper via the central valve block, a central recess, which is configured as a central bore, for example, and an annular gap connecting the annular space between the container pipe and the intermediate pipe with one of the damper valve devices, are advantageously used. For example, the base block is configured as a full pipe body. The base block is advantageously partially fitted with the air spring. In particular, this means that the air spring completely surrounds the base block in an axial portion.

A further preferred example embodiment of the vibration damper is characterized in that the central valve block has hydraulic connections. The hydraulic connections allow hydraulic lines to be connected to the central valve block. The central valve block, in particular the damper valve devices in the central valve block, can be connected to at least one hydraulic pressure source, for example a hydraulic pump, via the hydraulic lines. The hydraulic pressure source, in particular the hydraulic pump, serves to represent an active damping control in a motor vehicle equipped with the vibration damper. The three-pipe damper combined with the air spring is used in the motor vehicle with the active damping control to represent a suspension strut with an active damper and an active air spring.

A further preferred example embodiment of the vibration damper is characterized in that the hydraulic connections on the central valve block are combined with shut-off valves. This simplifies the assembly of the three-pipe damper. Depending on the design, the three-pipe damper can be mounted on the vehicle already pre-filled.

The invention further relates to a motor vehicle having an active chassis comprising at least one previously described vibration damper. The motor vehicle advantageously comprises a front axle and a rear axle each equipped with a motor pump unit and two vibration dampers.

The invention further relates to a container pipe, an intermediate pipe, a main pipe, a central valve block, a gas bag, a control sleeve, a control ring and/or a spacer sleeve for a previously described vibration damper. The individual parts of the vibration damper may be sold separately.

### BRIEF DESCRIPTION OF THE DRAWINGS

Further advantages, features, and details of the invention arise from the following description, in which various example embodiments of the invention are individually described in detail with reference to the drawing. The figures show:

FIG. 1 shows a perspective view of a suspension strut with a three-pipe damper;

FIG. 2 shows the three-pipe damper of FIG. 1 in a schematic cross-sectional view;

FIG. 3 shows the three-pipe damper of FIG. 1 in a longitudinal sectional view, wherein a container pipe of the three-pipe damper is not shown in section;

FIG. 4 shows a perspective view of a vibration damper having a three-pipe damper that is surrounded with an air spring at one end facing a front axle;

FIG. 5 shows a vibration damper having a three-pipe damper associated with a rear axle of a motor vehicle; and

FIGS. 6 to 11 show three longitudinal sectional views and three perspective views of details of a hydraulic end position damping of the vibration damper of FIG. 2.

### DETAILED DESCRIPTION OF THE INVENTION

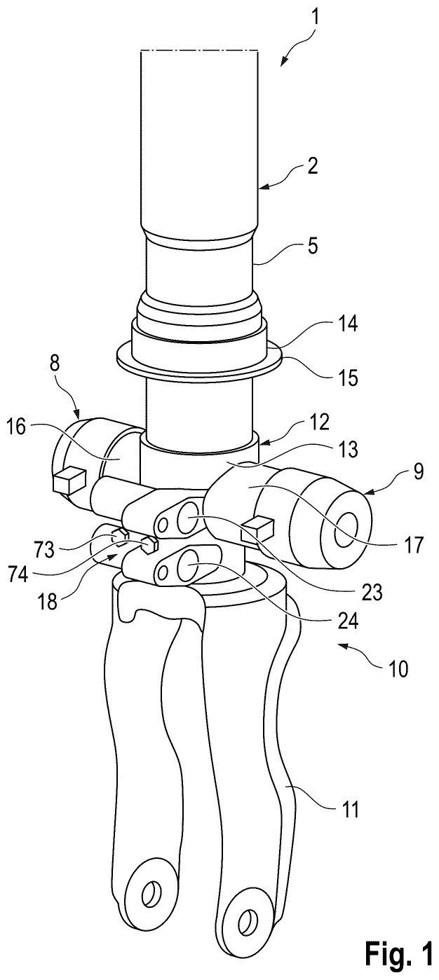

FIGS. 1 to 3 shows a suspension strut 10 with a spring fork 11 in various views. The suspension strut 10 comprises a vibration damper 1, also referred to as a shock absorber. The vibration damper 1 is configured as a three-pipe damper 2 having a main pipe 3, an intermediate pipe 4 and a container pipe 5.

The suspension strut 10 with the vibration damper 1, which is designed as a three-pipe damper 2, is part of a hydraulic system that serves in a motor vehicle to represent an active damping control during operation of the motor vehicle. The motor vehicle preferably comprises four wheels, each of which is associated with a vibration damper 1 configured as a three-pipe damper 2. The three-pipe damper or vibration damper is also referred to as a damper for short. The hydraulic damper represents a shock absorber in an active chassis of a motor vehicle.

The three-pipe damper 2 is operated with a hydraulic medium. The hydraulic medium is preferably a hydraulic fluid, which will also be referred to as a hydraulic oil or shortened as “oil”. In addition to a hydraulic damper volume, the hydraulic damper comprises a gas balance volume 21.

The active damping control comprises a hydraulic actuator apparatus, which is hydraulically connected to the dampers via the hydraulic lines. The hydraulic actuator apparatus in the active chassis of the motor vehicle is used to stimulate or drive the hydraulic dampers in a targeted manner. To this end, the hydraulic actuator apparatus advantageously comprises a separate hydraulic pump for each damper. Two hydraulic pumps can be combined together in each axle of the motor vehicle into one motor-pump unit. The hydraulic pumps associated with the respective axle are advantageously controllable separately via a common control unit.

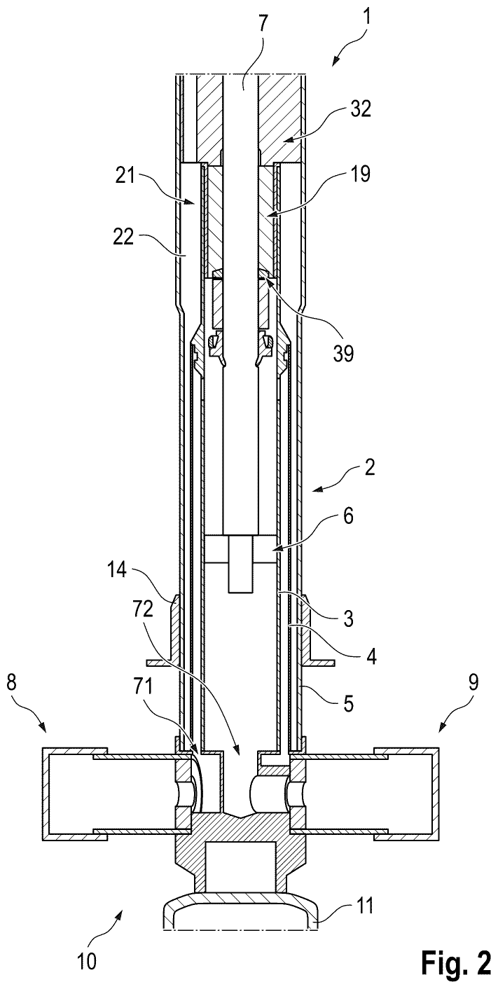

In the main pipe 3 of the three-pipe damper 2, a damper piston 6 in FIG. 2 can be moved back and forth and downwards and upwards. A piston rod 7 extends from the damper piston 6, which in FIG. 2 extends upwards out of the three-pipe damper 2 through a seal guide unit 32. An upper end of the piston rod 7 (not shown in FIG. 2) is connected to a support structure of the motor vehicle.

The main pipe 3, the intermediate pipe 4 and the container pipe 5 are arranged coaxially and provided with interstices in the radial direction. An annular space between the main pipe 3 and the intermediate pipe 4 allows the hydraulic medium to pass through, in particular a return line of the hydraulic medium downwards, without extra hydraulic lines. An annular space between the intermediate pipe 4 and the container pipe 5 advantageously serves to receive the gas balance volume 21.

The gas balance volume 21 is illustrated with a gas bag 22, which is received at a piston rod end of the three-pipe damper 2, i.e. in FIG. 2 above, between the intermediate pipe 4 and the container pipe 5. Radially within the gas balance volume 21, the piston rod 7 in the main pipe 3 is surrounded by a hydraulic end position damper 19 with a hydraulic pull stop 39.

At its lower end, in FIG. 2, the three-pipe damper 2 is equipped with a central valve block 12. Two damper valve devices 8 and 9 are integrated into the central valve block 12. The damper valve devices 8 and 9 each include a check valve.

Furthermore, the damper valve device 8 comprises a rebound valve that is hydraulically connected via an annular gap 71 to the annular space between the main pipe 3 and the intermediate pipe 4. In FIG. 2, the main pipe 3 is connected to a pressure stage valve in the damper valve device 9 at the bottom via a relatively large central through-hole 72.

The central valve block 12 comprises a base block 13, which is configured as a full pipe body, for example. The outside of the base block 13 has the shape of a straight circular cylindrical shell, for example. For example, the base block 13 is configured as a milling part and attached to the lower end of the three-pipe damper 2.

The center valve block 12 further comprises two damper valve blocks 16, 17 that are substantially designed as straight circular cylinders. The two damper valve blocks 16, 17 may be integrally connected to the base block 13. The damper valve blocks 16, 17 serve to receive and/or represent the damper valve devices 8 and 9. The two damper valve blocks 16, 17 are arranged coaxially to each other and transversely to the longitudinal axis of the three-pipe damper 2.

The center valve block 12 further comprises a connection valve block 18. The connection valve block 18 is configured as a separate component and is attached to the base block 13. For example, two screws 73, 74 serve to attach the connection valve block 18 to the base block 13 of the central valve block 12.

The design of the connection valve block 18 as a separate component has the advantage, among other things, that a package-dependent design of the vibration damper is possible with relatively little design effort, in particular when installed in different motor vehicle variants or motor vehicle derivatives. Moreover, the separate connection valve block 18 can be designed and arranged on the base block 13, such that special crash requirements for a motor vehicle equipped with the vibration damper 1 can be ideally met.

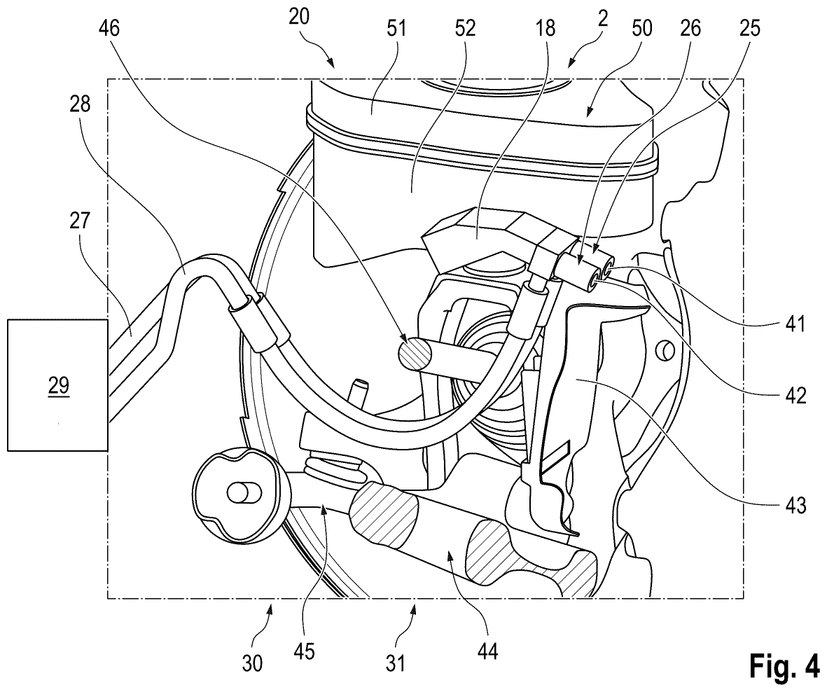

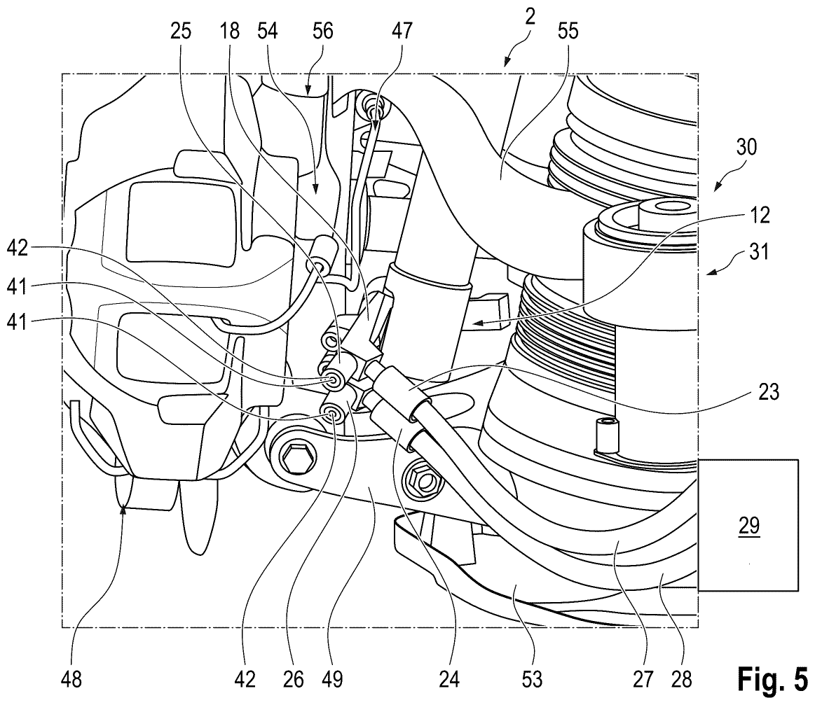

With regard to the package-dependent design of the connection valve block 18, the positioning of hydraulic connections 23, 24 is particularly important. The hydraulic connections 23, 24 at the connection valve block 18 serve to connect hydraulic lines 27, 28, as can be seen in particular in FIGS. 4 and 5. The three-pipe damper 2 can be actively hydraulically controlled via the hydraulic lines 27, 28. To this end, hydraulic lines 27, 28 are hydraulically incorporated into an active damping control 29 that is indicated in FIG. 4 only by a rectangle.

FIGS. 4 and 5 illustrate in a perspective view how the three-pipe damper 2 with the central valve block 12 at its lower end can be designed to suit the installation space, in particular when installed in a motor vehicle 30 with an active chassis 31.

The motor vehicle 30 indicated in FIGS. 4 and 5 only with the aid of various components 43 to 46 in FIGS. 4 and 47 to 49, 53 to 56 in FIG. 5 places high demands on a designer, in particular also because hoses and lines, in particular the hydraulic lines 27, 28, require sufficient clearance to the surrounding components over the entire spring and steering stroke during operation of the motor vehicle 30. Furthermore, bend radii and stretch lengths that occur must be observed.

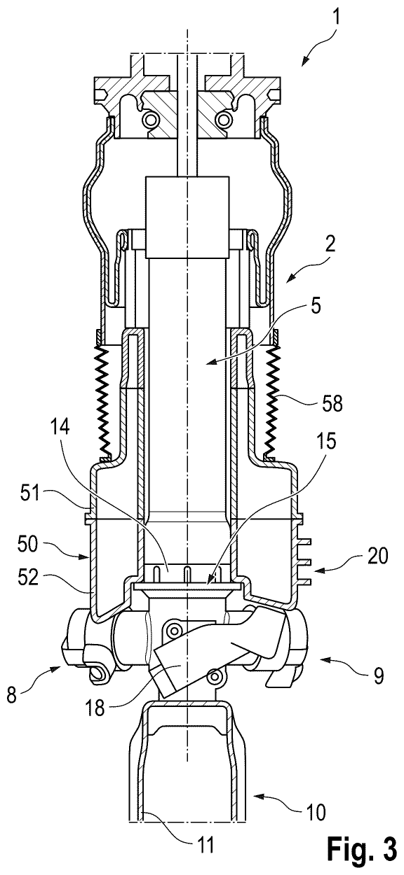

An additional design effort results from the fact that the vibration damper 1 configured as a three-pipe damper 2 is combined with an air spring 20, as can be seen in FIG. 3, for example. The air spring 20 is advantageously configured and arranged, such that the air spring 20 surrounds the central valve block 12 from the lower end of the three-pipe damper 2. On the one hand, this maximizes the air spring space that can be represented by the air spring 20. Due to the large volume, the air spring 20 can be designed to be advantageously softer. In addition, the design and arrangement of the air spring 20 on and around the central valve block 12 results in package advantages.

The air spring 20 includes an air spring housing 50 having a housing upper part 51 and a housing bottom part 52. The air spring housing 50 includes a single, relatively large air volume. The air spring housing 50 extends around the lower end of the three-pipe damper 2 with the central valve block 12. In the axial direction, the air spring housing 50 is arranged between a bellows 58 and the central valve block 12, which is partially surrounded by the housing bottom 52.

The air spring housing 50, with its housing lower part 52, is supported by an axial support ring 15, which is attached to the lower end of the three-pipe damper 2. The axial support ring 15 is combined with an adapter body 14, which allows the air spring housing 50 to be attached on the outside to the container pipe 5 of the three-pipe damper 2. The air spring housing 50 is attached to the adapter body 14, for example by means of a snap connection or a latch connection.

FIG. 4 shows how the air spring housing 50 of the air spring 20 surrounds the central valve block 12, such that the connection valve block 18 remains free. In FIG. 4, the three-pipe damper 2 is associated with a front axle of the motor vehicle 30. Component 43 is a brake air supply. Component 44 is a lower transverse link. Component 45 is a tie rod. Component 46 is a cardan shaft.

FIG. 4 shows how the air spring volume of the air spring 20 extends around the connection valve block 18. Thus, a maximum air spring volume may be represented with the air spring housing 50. Moreover, FIG. 4 shows that the connection valve block 18 is designed such that, on the one hand, the connection of the hydraulic lines 27, 28 to the center valve block 12 is simplified. Moreover, shut-off screws 41, 42 of shut-off valves 25, 26 integrated in the connection valve block 18 are still accessible even when the air spring 20 is mounted.

In FIG. 5, the three-pipe damper 2 is associated with a rear axle of the motor vehicle 30. Component 47 is a further hydraulic line. Component 48 is a brake caliper. Component 49 is a lower transverse link. Component 53 is a transverse link cover. Component 54 is a holder with a brake line. Component 55 is an upper transverse link. Component 56 is a wheel carrier.

It can be seen in FIG. 5 that the connection valve block 18 is purposefully designed such that sufficient clearance to the wheel carrier 56 exists over the entire spring and steering stroke. Moreover, the connection valve block 18 and the hydraulic lines 27, 28, as well as the further hydraulic line 47, are designed such that sufficient clearance to the brake peripheries exists over the entire spring and steering stroke.

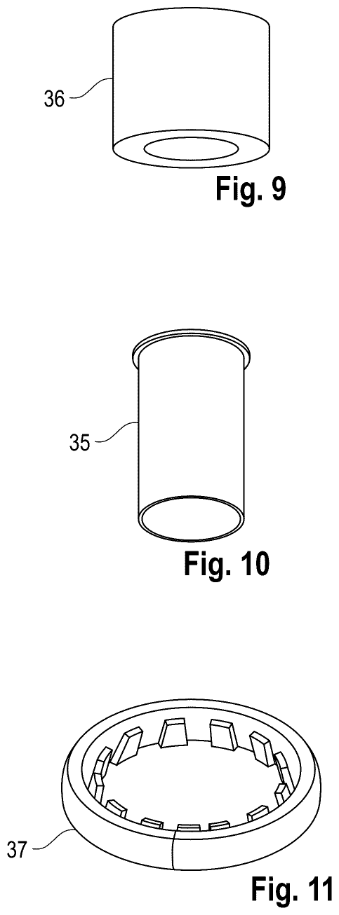

FIGS. 6 to 11 show how the hydraulic end position damping works with the hydraulic pull stop 39 in the three-pipe damper. The hydraulic pull stop 39 comprises a control sleeve 35 shown alone in perspective in FIG. 10, a spacer sleeve 36 shown alone in perspective in FIG. 9, and a control ring 37 shown alone in perspective in FIG. 11.

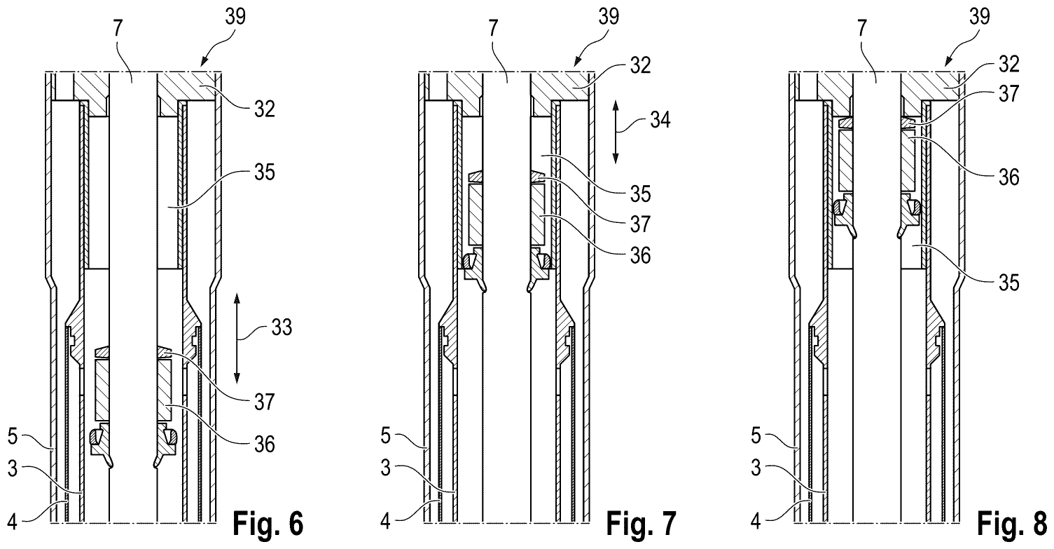

FIGS. 6 and 7 show how the control sleeve 35, the spacer sleeve 36 and the control ring 37 are mounted on the piston rod 7. The control sleeve 35 is suspended with a collar at the upper end of the main pipe 3. The control sleeve 35 controls a force build-up characteristic during operation of the hydraulic pull stop 39. In FIG. 6, a K0 position is shown. A free stroke/pull from K0 is indicated by a double arrow 33.

In FIG. 7 illustrates the application point of the hydraulic pull stop 39. The effective length of the hydraulic pull stop 39 is indicated by a double arrow 34. The application point and the effective length are directly dependent on each other. The hydraulic force may be adjusted at the pull stop 39 via the design of the control ring 37.

What is claimed is:

1. A vibration damper comprising:
a container pipe, a main pipe arranged in the container pipe, and an intermediate pipe arranged between the main pipe and the container pipe, wherein the main pipe, the intermediate pipe and the container pipe are arranged coaxially and constitute a three-pipe damper; and
a damper piston which is configured to be moved back and forth in the main pipe and in an axial direction relative to the main pipe,
wherein the damper piston is attached to an end of a piston rod,
wherein the three-pipe damper is equipped with a hydraulic end position damper,
wherein the three-pipe damper has, at an end facing away from the piston rod, (i) a central valve block at least partially surrounded by an air spring and (ii) two damper valve devices,
wherein the three-pipe damper has a gas balance volume at an end on the piston rod, which gas balance volume is arranged in an annular space between the intermediate pipe and the container pipe.

2. The vibration damper according to claim 1, wherein an axial dimension of the gas balance volume in the annular space between the intermediate pipe and the container pipe is longer than one tenth of the axial dimension of the main pipe of the three-pipe damper.

3. The vibration damper according to claim 1, further comprising a gas bag arranged in the annular space between the intermediate pipe and the container pipe, which gas bag constitutes the gas balance volume.

4. The vibration damper according to claim 1, wherein a radial distance between the main pipe and the intermediate pipe is less than a radial distance between the intermediate pipe and the container pipe.

5. The vibration damper according to claim 1, wherein the hydraulic end position damper comprises a hydraulic pull stop having a control sleeve, a control ring, and a distance sleeve.

6. The vibration damper according to claim 1, wherein the central valve block comprises a base block extending in extension of the container pipe and from which two damper valve blocks extend, which extend coaxially to each other in opposite directions radially outwards.

7. The vibration damper of claim 1, wherein the central valve block comprises hydraulic connections.

8. The vibration damper according to claim 1, wherein the hydraulic connections on the central valve block are combined with shut-off valves.

9. A motor vehicle having an active chassis comprising the vibration damper according to claim 1.
